(19) United States
(12) Patent Application Publication
(10) Pub. No.: US 2016/0069588 A1
(43) Pub. Date: Mar. 10, 2016

(54) HEAT MEDIUM HEATING DEVICE, METHOD OF MANUFACTURING SAME, AND VEHICLE AIR CONDITIONING DEVICE USING SAME

(71) Applicant: MITSUBISHI HEAVY INDUSTRIES AUTOMOTIVE THERMAL SYSTEMS CO., LTD., Kiyosu-shi, Aichi (JP)

(72) Inventors: Satoshi KOMINAMI, Kiyosu-shi, Aichi (JP); Shiro MATSUBARA, Kiyosu-shi, Aichi (JP)

(73) Assignee: MITSUBISHI HEAVY INDUSTRIES AUTOMOTIVE THERMAL SYSTEMS CO., LTD., Kiyosu-shi, Aichi (JP)

(21) Appl. No.: 14/783,173

(22) PCT Filed: May 8, 2014
(86) PCT No.: PCT/JP2014/062380

§ 371 Date: Oct. 8, 2015

(30) Foreign Application Priority Data
May 15, 2013 (JP) 2013-103155

(51) Int. Cl. F24H 1/14; B60H 1/22; B23P 15/26

(52) U.S. Cl. CPC F24H 1/142; B23P 15/26; B60H 1/2221

(57) ABSTRACT

The heat medium heating device is provided with the following: a plurality of flat heat exchange tubes in which U-turn flow channels are formed; a heat medium inlet and outlet header to which heat medium inlet and outlet pipes are connected, and to which one end of each of the flat heat exchange tubes is connected at predetermined intervals and is jointed by brazing; and a plurality of sets of PTC heaters stacked between the flat heat exchange tubes. A heat exchange element comprising the flat heat exchange tubes, the heat medium inlet and outlet header, and the PTC heaters is sandwiched between a holding plate or a bottom face of a housing and a substrate mount, and is accommodated and installed within the housing in a state where the flat heat exchange tubes and the PTC heaters are in close contact.

TECHNICAL FIELD

The present invention relates to a heat medium heating device that heats a heat medium using a Positive Temperature Coefficient (PTC) heater, a method of manufacturing the same, and a vehicle air conditioning device using the same.

### BACKGROUND ART

A heat medium heating device that incorporates a PTC heater having a PTC element as heating element is used for heating a heat medium that is a source of heat for space heating in air conditioning devices for vehicles such as electric vehicles, and hybrid vehicles. For example, Patent Documents 1 and 2 disclose as such a heat medium heating device a device in which a plurality of flat heat exchange tubes forming a flow channel through which a heat medium flows, and PTC heaters are disposed therebetween in close contact, so that the heat medium flowing within the flat heat exchange tubes is heated by the heat generated by the PTC heaters.

In the devices disclosed in Patent Documents 1 and 2, a plurality of flat heat exchange tubes formed integrally with a tank part and a plurality of sets of PTC heaters are alternately stacked while inserting a sealing member between the tank part, and by pressing and securing the plurality of flat heat exchange tubes and the plurality of sets of PTC heaters against a bottom face of a housing with a pressing member, the sealing between the tank part and the contact between the flat heat exchange tubes and the PTC heaters are ensured. Alternatively, sealing between the tank part of the plurality of flat heat exchange tubes is carried out by brazing, the PTC heaters are incorporated by pressing out between the tubes, and the plurality of flat heat exchange tubes and the PTC heaters are pressed and secured against the bottom face of the housing with a pressing member, to ensure close contact between the flat heat exchange tubes and the PTC heaters.

On the other hand, Patent Document 3 discloses a radiator and cooling device configured such that cooling medium inlet and outlet header is brazed to, or a resin cooling medium inlet and outlet header is insert formed to one end of a plurality of flat heat exchange tubes having U-turn flow channels, a plurality of plate fins are press fit to or corrugated fins are sandwiched and brazed to the periphery of the flat heat exchange tubes and the fins are in thermal contact.

### CITATION LIST

### Patent Literature(s)

Patent Document 1: Japanese Unexamined Patent Application Publication No. 2012-214207A

Patent Document 2: Japanese Unexamined Patent Application Publication No. 2012-218557A

Patent Document 3: Japanese Unexamined Patent Application Publication No. 2007-192441A

### SUMMARY OF INVENTION

### Technical Problem

In the devices of Patent Document 1 and 2, in the configuration in which flat heat exchange tubes and the PTC heaters are alternately stacked, pressed and secured, it is essential to interpose the seal material between the tank part, so the reliability of the seal member and the assemblability are remaining issues, and there are issues such as a constraint on the direction for bringing out the heat medium inlet and outlet pipes that are connected to the tank part, and the like. Also, when the structure between the tank part is a brazed structure, the issue regarding the sealing material to be used is resolved, but when the PTC heaters are insulated and incorporated, it is necessary to ensure the gap between tubes. Therefore, positioning the PTC heaters with good accuracy for incorporation is reasonably difficult, so the assemblability is an issue.

On the other hand, as indicated in Patent Document 3, it has been widely known that by configuring the flat heat exchange tubes and the heat medium inlet and outlet header as separate structures, and jointing and sealing them integrally by brazing or another method, it is possible to obtain a heat exchanger that does not require a seal member between the tank part. However, virtually all such heat exchangers have fins sandwiched between the tubes and brazed, or press fit so that there is thermal contact. Therefore, even though the PTC heaters are incorporated between the plurality of flat heat exchange tubes with insulating sheets interposed therebetween, it is reasonably difficult to ensure the necessary gap between the flat heat exchange tubes, and position and incorporate the PTC heaters with good accuracy as described above, so the assemblability was an issue.

In light of the foregoing, it is an object of the present invention to provide a heat medium heating device, method of manufacturing the same, and vehicle air conditioning device using the same that eliminates the issues regarding tank part sealability and assemblability of the PTC heaters, and moreover provides a degree of freedom in the position and direction of bringing out the hear medium inlet and outlet pipes, and has higher mountability.

### Solution to Problem

In order to solve the above problem, the heat medium heating device, the method of manufacturing the same, and the vehicle air conditioning device using the same according to the present invention adopt the following means.

Namely, the heat medium heating device according to a first aspect of the present invention is a heat medium heating device that heats a heat medium using PTC heaters, and that includes: a plurality of flat heat exchange tubes, each flat heat exchange tube being formed with a U-turn flow channel, the heat medium flowing in from one end thereof, making a U-turn at another end thereof, and returning to the one end; a heat medium inlet and outlet header connected to heat medium inlet and outlet pipes and to the one end of each of the flat heat exchange tubes at predetermined intervals with joints by brazing; and a plurality of sets of PTC heaters each stacked alternately between the plurality of flat heat exchange tubes. A heat exchange element comprising the flat heat exchange tubes, the heat medium inlet and outlet header, and the plurality of sets of PTC heaters is sandwiched between a holding plate or a bottom face of a housing and a substrate mount, and is accommodated and installed inside the housing in a state where the plurality of flat heat exchange tubes and the plurality of sets of PTC heaters are in close contact.

According to the first aspect of the present invention, the heat exchange element that includes the plurality of flat heat exchange tubes formed with U-turn flow channels, the heat medium inlet and outlet header that is connected to one end thereof and connected to the heat medium inlet and outlet pipes with joints by brazing, and the plurality of sets of PTC heaters that are each stacked alternately between the flat heat exchange tubes is sandwiched between the holding plate or the bottom face of the housing and the substrate mount, and is accommodated and installed within the housing in a state where the plurality of flat heat exchange tubes and the plurality of sets of PTC heaters are in close contact. Therefore, it is possible to configure a heat exchange element in a brazed structure with no seal, and the risk of leakage of the heat medium can be eliminated. Also, it is possible to increase the degree of freedom of connection position and direction of the inlet and outlet pipes with respect to the heat medium inlet and outlet header. Moreover, the plurality of flat heat exchange tubes and the plurality of sets of PTC heaters are sandwiched between the holding plate or the bottom face of the housing and the substrate mount, and are accommodated and installed within the housing in mutual close contact to each other, so it is possible to reduce the contact thermal resistance therebetween, and ensure the thermal conductivity. Therefore, it is possible to provide a heat medium heating device with no risk of leakage of heat medium and high reliability, with a high degree of freedom of positioning the take out of the inlet and outlet pipes and excellent mountability, and good efficiency and high performance.

In addition, the heat medium heating device according to a second aspect of the present invention is the heat medium heating device as described above, in which the plurality of flat heat exchange tubes is expanded, to bring the plurality of flat heat exchange tubes and the plurality of sets of PTC heaters into close contact.

According to the second aspect of the present invention, the plurality of flat heat exchange tubes and the plurality of sets of PTC heaters are brought into close contact by expanding the plurality of heat exchange tubes. Therefore, even though the PTC heaters are inserted maintaining a constant gap between each of the plurality of the flat heat exchange tubes, because the plurality of heat exchange tubes are expanded between the holding plate or the bottom face of the housing and the substrate mount, it is possible to reliably bring the plurality of flat heat exchange tubes and the plurality of sets of PTC heaters into mutual close contact. Therefore, facilitating incorporation of the PTC heaters between the flat heat exchange tubes and ensuring mutual close contact are both attained, so it is possible to improve the assemblability of the heat medium heating device and to achieve high performance.

In addition, the heat medium heating device according to a third aspect of the present invention is any of the heat medium heating devices as described above, in which a control substrate on which power transistors that control the supply of electrical power to the PTC heaters are mounted is installed on the substrate mount that is in contact with the outermost side flat heat exchange tube from among the plurality of flat heat exchange tubes.

According to the third aspect of the present invention, the control substrate on which the power transistors that control the power to the PTC heaters are mounted is installed on the substrate mount in contact with the outermost side flat heat exchange tube from among the plurality of flat heat exchange tubes. Therefore, the substrate mount that is in contact with the flat heat exchange tube acts as a heat sink, so it is possible to cool the power transistors such as IGBTs mounted on the control substrate. Therefore, it is possible to ensure the cooling performance of the power transistor, which is a heat generating component, so its action is stabilized and the control performance can be increased.

In addition, the heat medium heating device according to a fourth aspect of the present invention is any of the heat medium heating devices described above, in which the substrate mount is composed of an aluminum alloy having thermal conductivity.

According to the fourth aspect of the present invention, the substrate mount is composed of an aluminum alloy having thermal conductivity, so not only is it possible to ensure the stiffness for installing the control substrate and the thermal conductivity as a heat sink, but also the weight of the substrate mount can be reduced. Therefore, it is possible to improve both the cooling performance and the control performance of the heat medium heating device, and reduce the weight.

In addition, the heat medium heating device according to a fifth aspect of the present invention is any of the heat medium heating devices as described above, in which the flat heat exchange tubes, the substrate mount, and the control substrate each have substantially the same planar area.

According to the fifth aspect of the present invention, the flat heat exchange tubes, the substrate mount, and the control substrate each have substantially the same planar area. Therefore, when accommodating and installing the heat exchange element and the control substrate within the housing, it is possible to accommodate and install them with the most spatially efficient arrangement. Therefore, the housing and accordingly the heat medium heating device can be made small and compact, and the mountability on a vehicle or the like can be improved.

In addition, the heat medium heating device according to a sixth aspect of the present invention is any of the heat medium heating devices as described above, in which a terminal that extends from an electrode plate of the PTC heaters is bent towards the control substrate, and directly connected to a terminal mount provided on the control substrate.

According to the sixth aspect of the present invention, the terminal that extends from the electrode plate of the PTC heaters is bent towards the control substrate, and is directly connected to the terminal amount provided on the control substrate. Therefore, the control substrate and the PTC heaters can be electrically connected directly via the terminals, without a harness. Therefore, the configuration can be simplified, assembly can be facilitated, and the cost can be reduced by the elimination of the harness.

In addition, the heat medium heating device according to a seventh aspect of the present invention is any one of the heat medium heating devices as described above, in which the flat heat exchange tube connection side of the heat medium inlet and outlet header is made from a clad material that is clad with brazing material on the outer face thereof, and the flat heat exchange tubes are made from a clad material that is clad with brazing material only on the inner face side thereof.

According to the seventh aspect of the present invention, the flat heat exchange tube connection side of the heat medium inlet and outlet header is made from a clad material that is clad with brazing material on the outer face thereof, and the flat heat exchange tubes are made from a clad material that is clad with brazing material only on the inner face side thereof. Therefore, reliable joints by brazing can be made between each of the flat heat exchange tubes and the heat medium inlet and outlet header by the brazing material clad on the outer face of the heat medium inlet and outlet header on the flat heat exchange tube connection side. Also, brazing material is made from a clad material that is clad only on the inner face side of the flat heat exchange tubes, and there is no brazing material on the outer face, so it is possible to prevent damage due to the brazing material to insulating sheet interposed when inserting and installing the PTC heaters between the flat heat exchange tubes. Therefore, the quality and reliability of the heat medium heating device can be improved.

Also, the heat medium heating device according to an eighth aspect of the present invention is any of the heat medium heating devices described above, in which the housing has a box shape, on one side face of the housing through holes through which the inlet and outlet pipes penetrate and which are then sealed are provided, and the housing is configured from a lower housing and an upper housing provided with a parting line that is inclined from above the pipe penetration face towards the bottom portion of an opposing face that is opposite to the one side face, and the heat exchange element is accommodated and installed on the lower housing, and the top portion of the housing can be sealed by the upper housing.

According to the eighth aspect of the present invention, the housing has a box shape, on one side face of the housing through holes through which the inlet and outlet pipes penetrate and which are then sealed are provided, and the housing is configured from a lower housing and an upper housing provided with a parting line that is inclined from above the pipe penetration face towards the bottom portion of an opposing face that is opposite to the one side face, and the heat exchange element is accommodated and installed on the lower housing, and the top portion of the housing can be sealed by the upper housing. Therefore the lower housing does not have an opposing face of the pipe penetration face, and when incorporating the heat exchange element into the box shaped housing, the inlet and outlet pipes can be inserted into the through holes of the pipe penetration face by moving the heat exchange element along the bottom face of the lower housing from the horizontal direction with the upper housing removed. Then, after the peripheries of the holes have been sealed and the heat exchange element has been accommodated and installed, the top portion of the housing is sealed by the upper housing, to assemble the heat medium heating device. Therefore, it is not necessary to provide space necessary for penetrating the inlet and outlet pipes of the heat exchange element into the through holes of the pipe penetration face within the housing, so the housing and therefore the heat medium heating device can be made smaller and more compact by that amount, so the cost can be reduced and the mountability onto the vehicle can be improved.

In addition, the heat medium heating device according to a ninth aspect of the present invention is any one of the heat medium heating devices described above, in which the housing has a box shape, one side face provided with through holes through which the inlet and outlet pipes penetrate is a side lid, and the top face thereof is a top lid, each configured to be freely attachable and removable, and the housing can be sealed by removing the side lid and penetrating the inlet and outlet pipes of the heat exchange element through the through holes thereof and sealing them, inserting the heat exchange element into the housing from the aperture formed by removing the side lid, and after fixing and installing the heat exchange element assembling the side lid and the top lid onto the housing.

According to the ninth aspect of the present invention, the housing has a box shape, the one side face provided with through holes through which the inlet and outlet pipes penetrate is a side lid, and the top face thereof is a top lid, each configured to be freely attachable and removable, and the housing can be sealed by removing the side lid and penetrating the inlet and outlet pipes of the heat exchange element through the through holes thereof and sealing them, inserting the heat exchange element into the housing from the aperture formed by removing the side lid, and after fixing and installing the heat exchange element, assembling the side lid and the top lid onto the housing. Therefore, when incorporating the heat exchange element into the box shaped housing, the side lid on the one side face through which the inlet and outlet pipes are to penetrate and the top lid are removed, the inlet and outlet pipes of the heat exchange element are penetrated through the through holes of the side lid and the peripheries of the holes are sealed, then the heat exchange element that is integrated with the side lid is inserted into the housing from the aperture formed by removing the side lid, and after fixing and installing the heat exchange element, the side lid and the top lid are assembled onto the housing and the housing is sealed, thereby to assemble the heat medium heating device. Therefore, it is not necessary to provide space necessary for penetrating the inlet and outlet pipes of the heat exchange element into the through holes within the housing, so the housing and therefore the heat medium heating device can be made smaller and more compact by that amount, so the cost can be reduced and the mountability onto the vehicle can be improved.

In addition, the heat medium heating device according to a tenth aspect of the present invention is any of the heat medium heating devices described above, in which the housing has a box shape, a face thereof opposite one side face that includes through holes through which the inlet and outlet pipes penetrate is a side lid, and a top face is a top lid, each configured to be freely attachable and removable, and the housing can be sealed by inserting the heat exchange element into the housing from the aperture formed by removing the side lid, penetrating the inlet and outlet pipes through the through holes of the one side face and sealing the inlet and outlet pipes, and after accommodating and installing the heat exchange element within the housing, assembling the side lid and the top lid onto the housing.

According to the tenth aspect of the present invention, the housing has a box shape, a face thereof opposite one side face that includes through holes through which the inlet and outlet pipes penetrate is a side lid, and a top face is a top lid, each configured to be freely attachable and removable, and the housing can be sealed by inserting the heat exchange element into the housing from the aperture formed by removing the side lid, penetrating the inlet and outlet pipes through the through holes of the one side face and sealing the inlet and outlet pipes, and after accommodating and installing the heat exchange element within the housing, assembling the side lid and the top lid onto the housing. Therefore, when incorporating the heat exchange element into the box shaped housing, the side lid on the face opposite the one side face through which the inlet and outlet pipes are to penetrate and the top lid are removed, the heat exchange element is inserted from the aperture formed by removing the side lid, the inlet and outlet pipes are penetrated through the through holes in the one side face and the peripheries of the holes are sealed, and after accommodating and installing the heat exchange element within the housing, the side lid and the top lid are assembled onto the housing thereby sealing the housing, to assemble the heat medium heating device. Therefore, it is not necessary to provide space necessary for penetrating the inlet and outlet pipes of the heat exchange element into the through holes within the housing, so the housing and therefore the heat medium heating device can be made smaller and more compact by that amount, so the cost can be reduced and the mountability onto the vehicle can be improved.

Also, the heat medium heating device according to an eleventh aspect of the present invention is any of the heat medium heating devices described above, in which a harness penetration part through which a High Voltage (HV) harness and an Low Voltage (LV) harness penetrate are provided on one side face of the box shaped housing, and the HV harness and the LV harness with a connector that are mounted on the harness penetration part are connected to the control substrate provided on the substrate mount.

According to the eleventh aspect of the present invention, the harness penetration part through which the HV harness and the LV harness penetrate is provided on one side face of the box shaped housing, and the HV harness and the LV harness with a connector that are mounted on the harness penetration part are connected to the control substrate provided on the substrate mount. Therefore, after the heat exchange element is accommodated and installed within the housing via the substrate mount, and before assembling the upper housing or the top lid, the HV harness and the LV harness that are inserted from the harness penetration part of the side face of the housing are connected to the control substrate on the substrate mount, so it is possible to easily connect the harnesses to the control substrate from the outside. Therefore, the external cable structure to the control substrate is simplified, and it is possible to facilitate assembly of the heat medium heating device.

In addition, a method of manufacturing the heat medium heating device according to a twelfth aspect of the present invention is a method of manufacturing any of the heat medium heating devices described above, by either (1) making a sub-assembly by incorporating the heat exchange element between the holding plate and the substrate mount, expanding the plurality of flat heat exchange tubes to bring the plurality of flat heat exchange tubes and thus the plurality of sets of PTC heaters into mutual close contact, and then accommodating and installing by incorporating the sub-assembly into the housing, or (2) incorporating the heat exchange element between a bottom face of the housing and the substrate mount, expanding the plurality of flat heat exchange tubes, to bring the plurality of heat exchange tubes and the plurality of sets of PTC heaters into mutual close contact, and thereby accommodating and installing the heat exchange element within the housing.

According to the twelfth aspect of the present invention, either (1) making a sub-assembly by incorporating the heat exchange element between the holding plate and the substrate mount, expanding the plurality of flat heat exchange tubes to bring the plurality of flat heat exchange tubes and the plurality of sets of PTC heaters into mutual close contact, and then accommodating and installing by incorporating the sub-assembly into the housing, or (2) incorporating the heat exchange element between a bottom face of the housing and the substrate mount, and expanding the plurality of flat heat exchange tubes to bring the plurality of heat exchange tubes and the plurality of sets of PTC heaters into mutual close contact, and thereby accommodating and installing the heat exchange element within the housing. Therefore, by either of methods (1) or (2), it is possible to ensure that the plurality of flat heat exchange tubes and the plurality of sets of PTC heaters are installed in mutual close contact, by expanding the plurality of heat exchange tubes after inserting and installing the PTC heaters while maintaining a constant gap between each of the plurality of flat heat exchange tubes. Therefore, facilitating stacking and assembly of the PTC heaters between the flat heat exchange tubes and ensuring mutual close contact are both attained, so the assemblability of the heat medium heating device can be improved and its performance increased.

In addition, the vehicle air conditioning device according to a thirteenth aspect of the present invention is configured so that heat medium heated by a heat medium heating device can be circulated to a radiator disposed in an air flow channel, and the heat medium heating device is any of the heat medium heating devices described above.

According to the thirteenth aspect of the present invention, heat medium heated by any of the heat medium heating devices described above can be circulated to the radiator disposed in the air flow channel. Therefore, the heat medium supplied to the radiator disposed on the air flow channel can be heated and supplied by the heat medium heating device with no risk of heat medium leakage, and the heat medium heating device can be provided with a high degree of freedom of positioning the take out of the inlet and outlet pipes, having excellent mountability, good efficiency, and high performance. Therefore, it is possible to improve the air conditioning performance, in particular the heating performance, of the vehicle air conditioning device, and improve the mountability of the air conditioning device in the vehicle.

### Advantageous Effects of Invention

According to the heat medium heating device of the present invention, the heat exchange element is of a brazed structure with no seal, so the risk of leakage of heat medium is eliminated, and the degree of freedom of connection position and the direction of the inlet and outlet pipes with respect to the heat medium inlet and outlet header can be increased. Moreover, the plurality of flat heat exchange tubes and the plurality of sets of PTC heaters are sandwiched between the holding plate or the bottom face of the housing and the substrate mount, and are accommodated and installed within the housing in mutual close contact, so it is possible to reduce the contact thermal resistance therebetween, and ensure the thermal conductivity. Therefore, it is possible to provide a heat medium heating device with no risk of leakage of heat medium and high reliability, with a high degree of freedom of positioning the take out of the inlet and outlet pipes and excellent mountability, and good efficiency and high performance.

Also, according to the method of manufacturing the heat medium heating device of the present invention, it is possible to reliably install the plurality of flat heat exchange tubes and the plurality of sets of PTC heaters in mutual close contact by expanding the plurality of flat heat exchange tubes after inserting the PTC heaters while maintaining a constant gap between each of the plurality of flat heat exchange tubes. Therefore, facilitating stacking and assembly of the PTC heaters between the flat heat exchange tubes and ensuring mutual close contact are both attained, so the assemblability of the heat medium heating device can be improved and its performance increased.

In addition, according to the vehicle air conditioning device of the present invention, the heat medium supplied to the radiator disposed on the air flow channel can be heated and supplied by the heat medium heating device with no risk of heat medium leakage, and with a high degree of freedom of positioning the take out of the inlet and outlet pipes and having excellent mountability, good efficiency, and high performance. Therefore, it is possible to improve the air conditioning performance, in particular the heating performance, of the vehicle air conditioning device, and improve the mountability of the air conditioning device in the vehicle.

### BRIEF DESCRIPTION OF DRAWING(S)

FIG. 1 is an external perspective view of a heat medium heating device according to a first embodiment of the present invention;

FIG. 2 is an exploded perspective view of the heat medium heating device illustrated in FIG. 1;

FIG. 3 is a vertical cross-sectional view of the heat medium heating device illustrated in FIG. 1;

FIG. 4 is a side view of a heat exchange element of the heat medium heating device illustrated in FIG. 1;

FIG. 5 is an exploded perspective view of the heat exchange element illustrated in FIG. 4;

FIG. 6 is an enlarged cross-sectional view of the heat medium inlet and outlet pipe take out part of the heat exchange element illustrated in FIG. 4;

FIG. 7 is a plan view of the flat heat exchange tubes, heat medium inlet and outlet header and the heat medium inlet and outlet pipes of the heat exchange element illustrated in FIG. 4;

FIG. 8 is a side view in the tube longitudinal direction of the flat heat exchange tubes, the heat medium inlet and outlet header, and the heat medium inlet and outlet pipes illustrated in FIG. 7;

FIG. 9 is a left side view of the flat heat exchange tubes, heat medium inlet and outlet header, and heat medium inlet and outlet pipes illustrated in FIG. 7;

FIG. 10 is an exploded perspective view of the flat heat exchange tubes, the heat medium inlet and outlet header, and the heat medium inlet and outlet pipes illustrated in FIG. 7;

FIG. 11 is a cross-sectional view of the flat heat exchange tubes illustrated in FIG. 7;

FIG. 12 is an exploded perspective view of a heat medium heating device according to a second embodiment of the present invention; and

FIG. 13 is an exploded perspective view of a heat medium heating device according to a third embodiment of the present invention.

### DESCRIPTION OF EMBODIMENTS

Embodiments of the present invention will be described below, referring to the attached drawings.

### First Embodiment

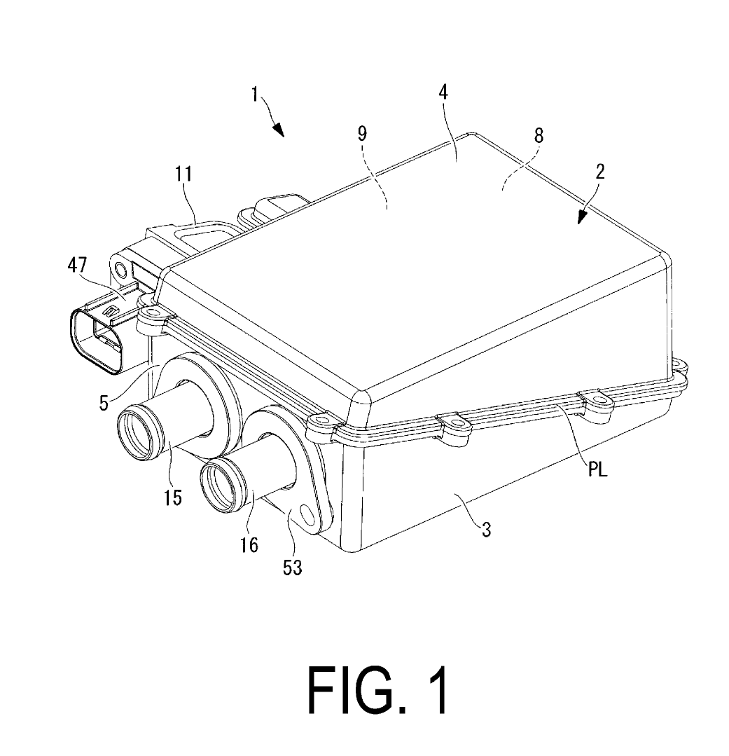

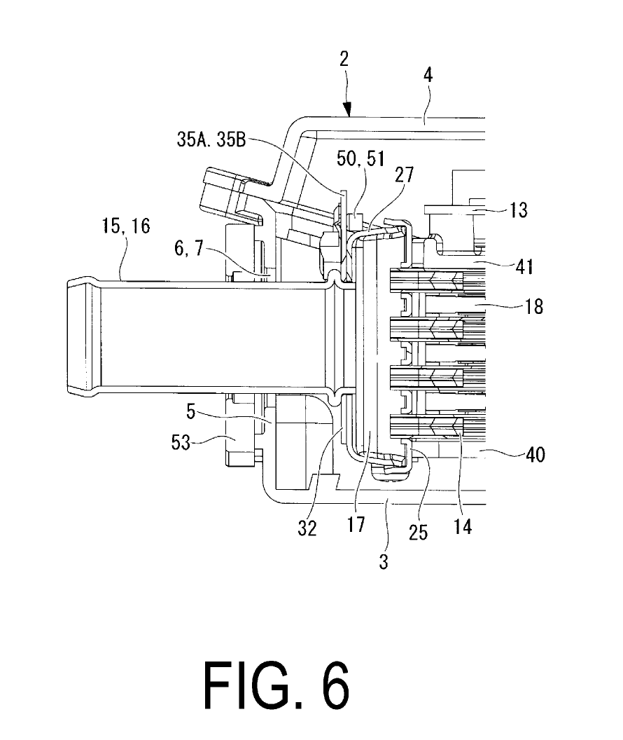

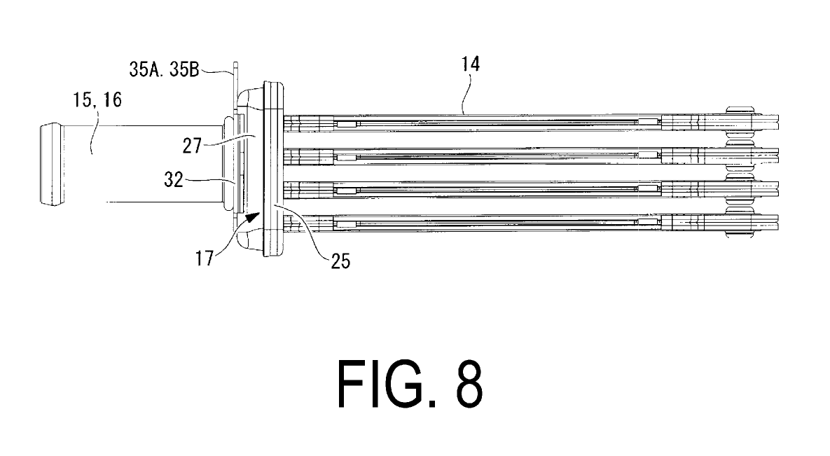

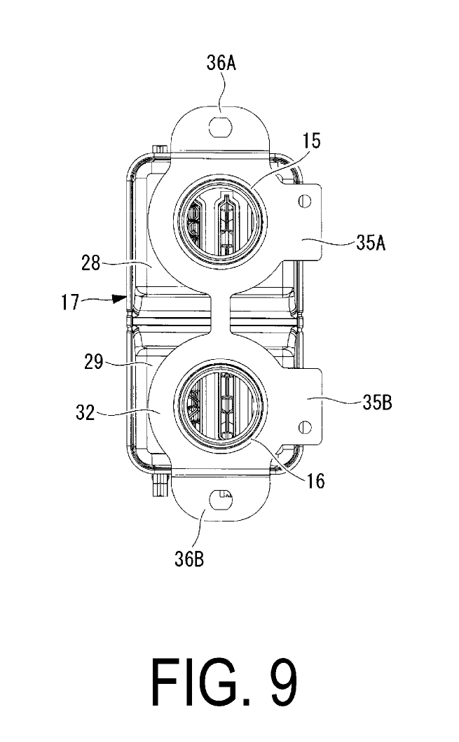

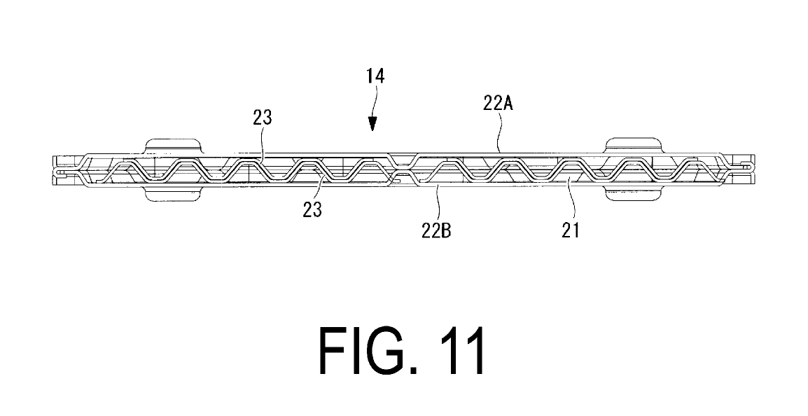

A first embodiment of the present invention will be described below, using FIG. 1 to FIG. 11.

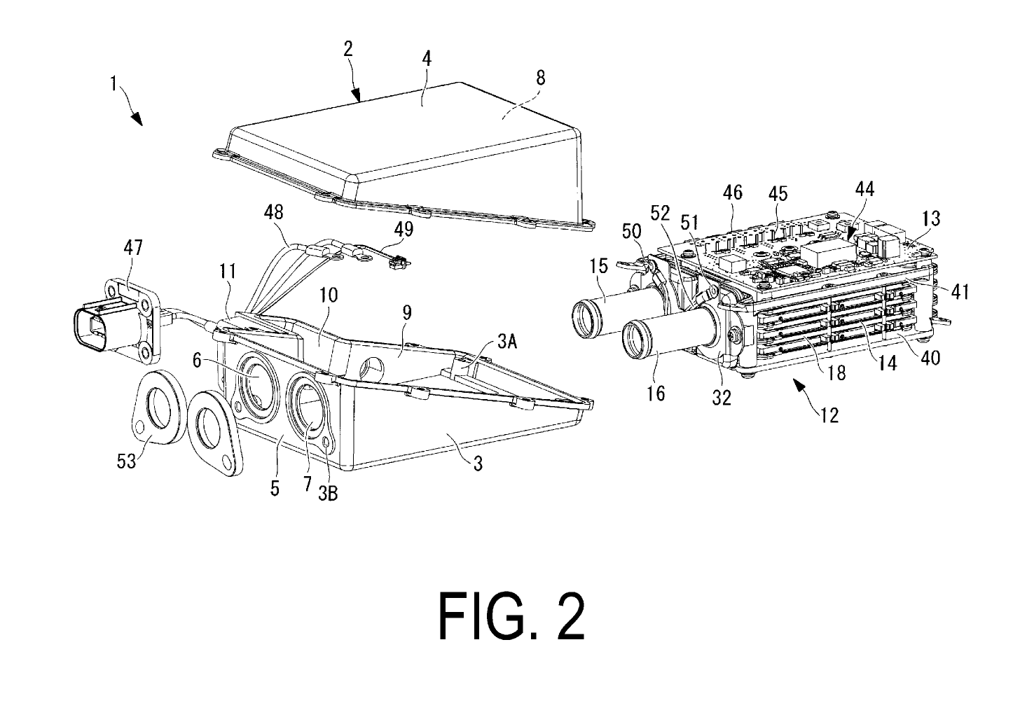

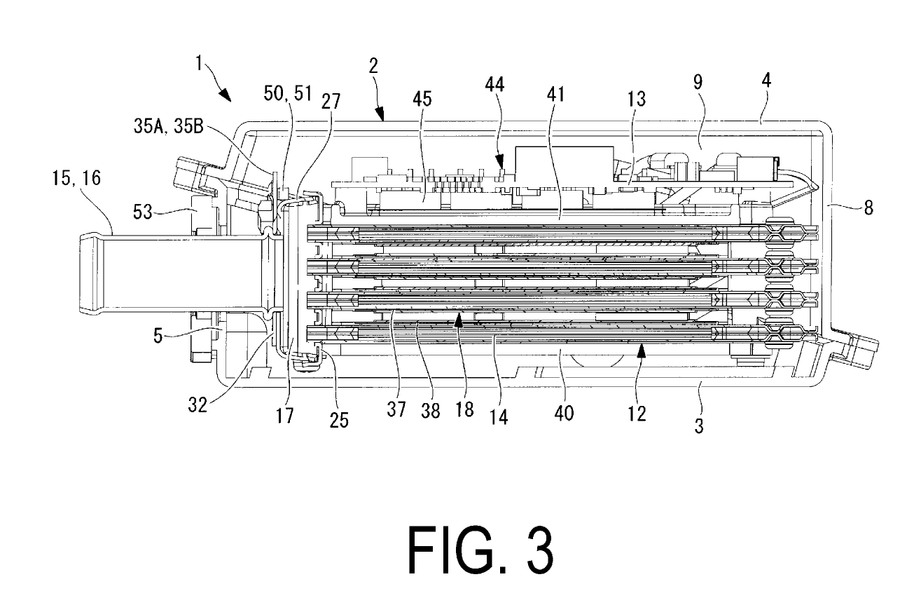

FIG. 1 is an external perspective view of a heat medium heating device according to the first embodiment of the present invention, FIG. 2 is an exploded perspective view thereof, and FIG. 3 is a vertical cross-sectional view thereof.

A heat medium heating device 1 is a device for heating heat medium that is a source of heat for space heating in a vehicle air conditioning device adapted for EVs, HVs or the like, configured to circulate the heat medium to/from radiators from which the vehicle air-conditioning device is configured using a heat medium pump. The heat medium heating device 1 includes a box shaped housing 2.

The box shaped housing 2 is configured with one side face as a pipe penetration face 5 provided with through holes 6, 7 through which heat medium inlet and outlet pipes 15, 16 (also simply referred to as inlet and outlet pipes) that are described later penetrate in a sealed manner. The box shaped housing 2 is divided vertically into a lower housing 3 and an upper housing 4 along a parting line PL that is provided inclined from the top portion of the pipe penetration face 5 towards the bottom portion of an opposing face 8. The upper housing 4 is fixed with screws to the lower housing 3 in which the internal components are assembled, with a liquid gasket or the like, to form the housing 2 with a sealed structure.

A harness penetration part (penetration part) 11 that includes a through hole 10 through which a HV harness 48 and an LV harness 49, which are described later, penetrate is provided on another side face 9 of the lower housing 3. Also, a plurality of bosses 3A for fastening a heat exchange element 12 that is described later with screws or the like are provided on the bottom face of the lower housing 3, and a plurality of bosses 3B for fastening a seal member 53 or the like for sealing the through holes 6, 7 after the heat medium inlet and outlet pipes 15, 16 have penetrated the through holes 6, 7 are provided on the pipe penetration face 5.

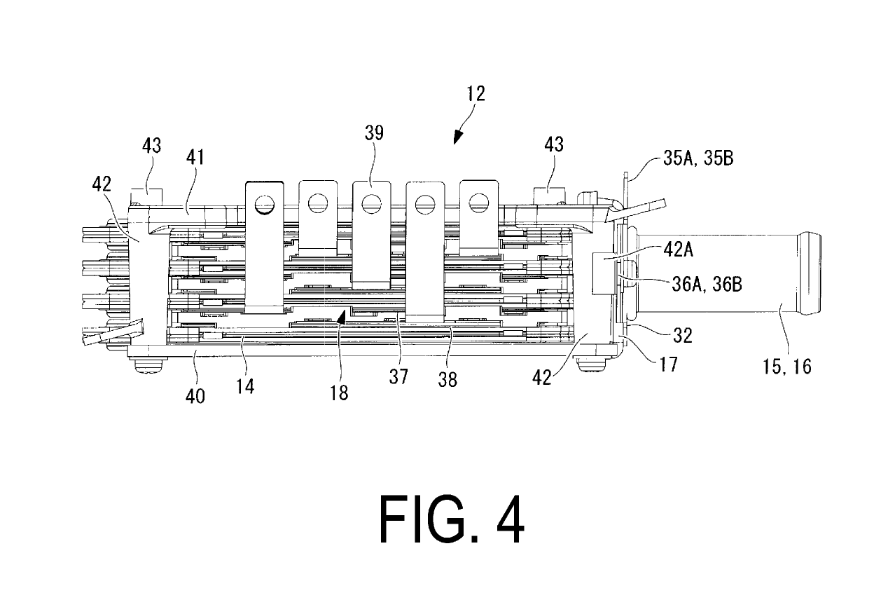

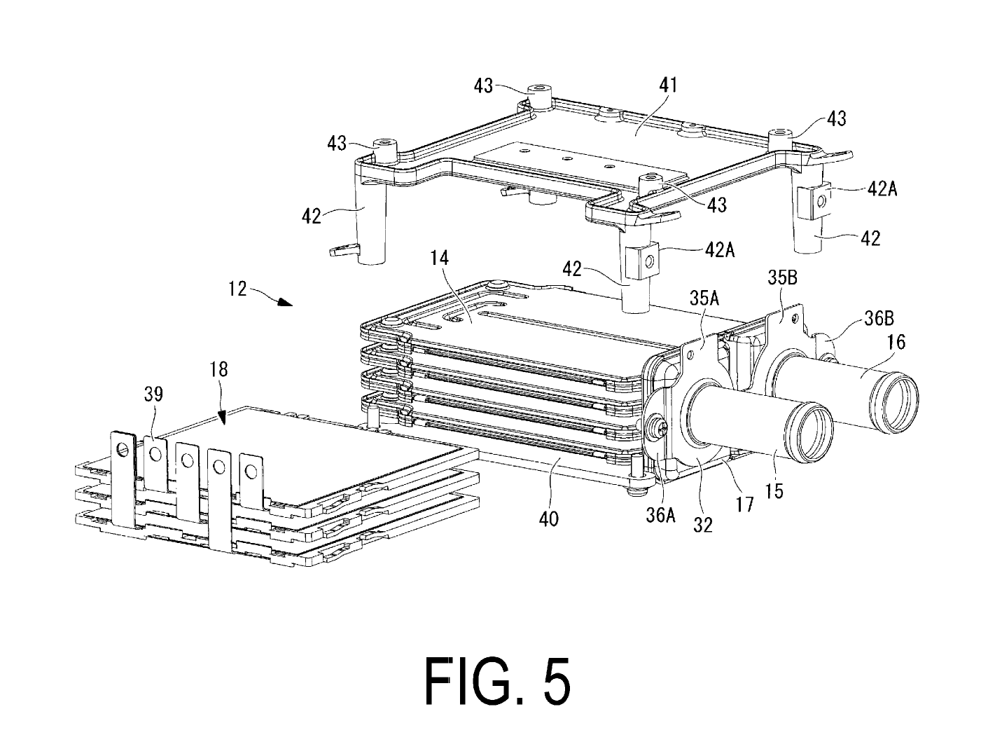

The heat exchange element 12 that exchanges heat with a heat medium that flows through the inlet and outlet pipes 15, 16 thereby heating the heat medium, and a control substrate 13 that controls the electrical power applied to PTC heaters 18 from which the heat exchange element 12 is configured are accommodated and installed within the housing 2. As illustrated in FIGS. 4 and 5, the heat exchange element 12 is configured from a plurality (in this embodiment, four) of flat heat exchange tubes 14, a heat medium inlet and outlet header 17 to which the plurality of flat heat exchange tubes 14 is connected at predetermined intervals, and the pair of heat medium inlet and outlet pipes 15, 16 is connected integrally with joints by brazing (welded joints), and the plurality of sets of PTC heaters 18 that are incorporated between the plurality of flat heat exchange tubes 14.

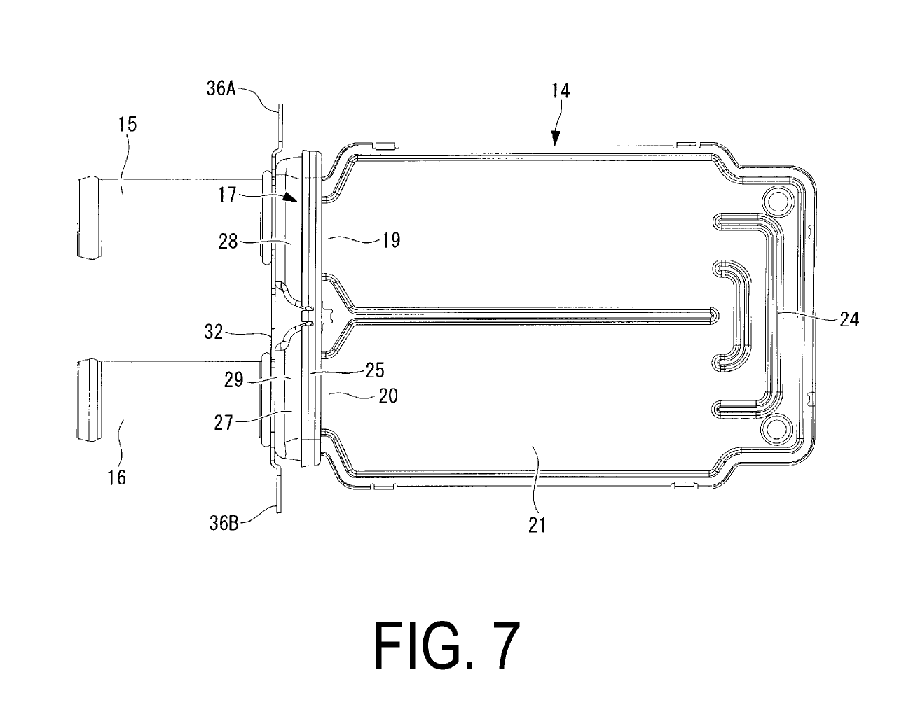

As illustrated in FIGS. 7 to 9, the heat exchange element 12 includes the plurality of (four) flat heat exchange tubes 14 in which U-turn flow channels 21 are formed so that heat medium that flows in from a heat medium inlet 19 provided at each end thereof makes U-turns at other end thereof and is returned to a heat medium outlet 20 provided at the one end thereof. Each of the heat medium inlets 19 and the heat medium outlets 20 are connected to the heat medium inlet and outlet header 17 by brazing, so that the four flat heat exchange tubes 14 are disposed vertically in four stages at predetermined intervals, so that each of the flat heat exchange tubes 14 and the heat medium inlet and outlet header 17 are integrated.

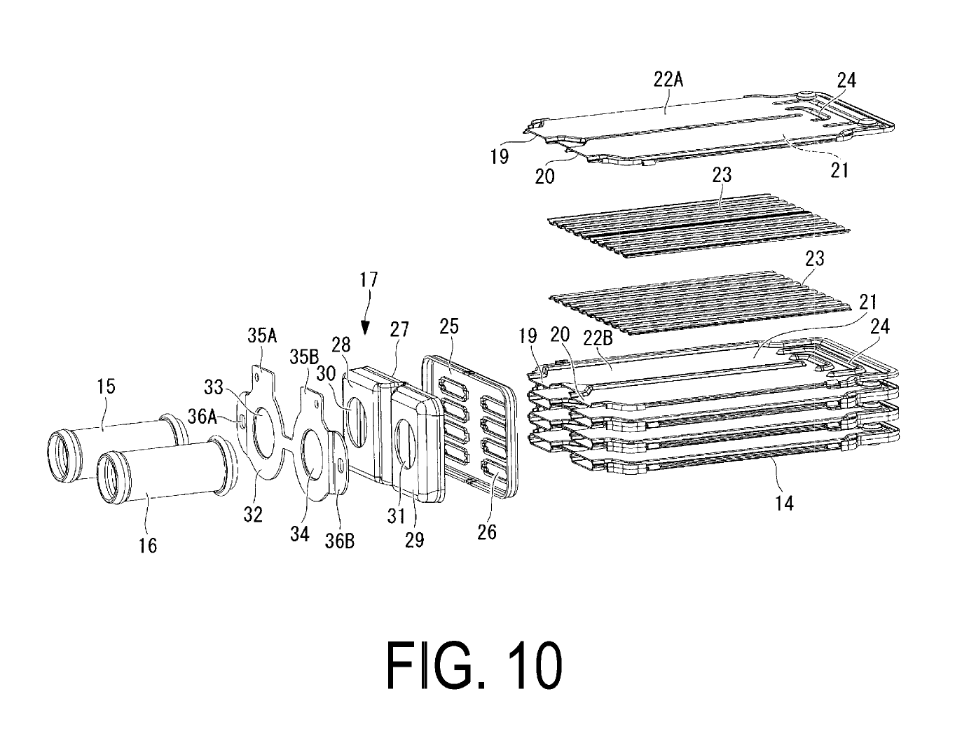

As illustrated in FIG. 10, each of the flat heat exchange tubes 14 is formed by butting together a pair of aluminum alloy top and bottom formed plates 22A, 22B with the U-turn flow channel 21 formed in a recess therein, with two superimposed aluminum alloy thin plate wavy inner fins 23 on which corrugations are formed inserted into the straight line portion of the U-turn flow channel 21, integrally jointed by brazing. A rib 24 projecting to the inner surface side of the formed plates 22A, 22B and forming a U-shape is integrally formed at the U-turn part of the U-turn flow channel 21.

The flat heat exchange tubes 14 are formed using a clad material that is clad only on the inner side of the formed plates 22A, 22B with brazing material (metal for brazing), and all the wavy inner fins 23 are formed from bare material. In the flat heat exchange tubes, the peaks on one side of one of the wavy inner fins 23 are jointed by brazing to the inner face of one of the formed plates 22A, and the peaks on one side of the other wavy inner fin 23 are jointed by brazing to the inner face of the other formed plate 22B. Also, the two superimposed wavy inner fins 23 that are aligned together at the center are not jointed, thereby providing a configuration that enables the tubes themselves to be easily expanded during tube expansion of the flat heat exchange tubes 14 that is described later, even though the inner fins have been inserted.

The heat medium inlet and outlet header 17 distributes the heat medium that flows in from the heat medium inlet pipe 15 to the plurality of flat heat exchange tubes 14, and causes the heat medium that has been heated by the PTC heaters 18 while flowing through each of the flat heat exchange tubes 14 to merge and flow out through the heat medium outlet pipe 16. The inlet and outlet header 17 as described above is integrated with the pair of heat medium inlet and outlet pipes 15, 16, and the plurality of flat heat exchange tubes 14 by joints by brazing.

As illustrated in FIG. 10, the heat medium inlet and outlet header 17 includes a header plate 25 formed from an aluminum alloy plate clad with brazing material on the outer face thereof, a header tank member 27 joined to the header plate 25, having an inlet header tank part 28 and an outlet header tank part 29 that are partitioned by a partition wall, and a pair of connection apertures 33, 34 for connecting the aluminum alloy header tank member 27 clad with brazing materials on the outer face thereof to the heat medium inlet and outlet pipes 15, 16, integrally joined to an aluminum alloy pipe connection member 32 shaped like eyeglasses disposed on the outer face of the header tank member 27.

Connection holes 26 for inserting and connecting the heat medium inlets 19 and heat medium outlets 20 of the plurality (four) of the flat heat exchange tubes 14 are provided in the header plate 25 in two columns, one on the left and one on the right, and with four rows in each column. Also, a heat medium inlet 30 that is linked to the heat medium inlet pipe 15 is provided in the inlet header tank part 28 of the header tank member 27, and a heat medium outlet 31 that is linked to the heat medium outlet pipe 16 is provided on the outlet header tank part 29. In addition, besides the pair of connection apertures 33, 34 provided on the pipe connection member 32, water temperature sensor installation members 35A, 35B that project above the top of each of the connection apertures 33, 34, and flanges 36A, 36B to which are screwed and fixed against a fixing portion 42A provided on legs 42 of a substrate mount 36 that is described later are integrally provided.

The heat medium inlet and outlet pipes 15, 16 are cylindrical shaped pipes with a predetermined length, that are inserted at one end thereof into the pair of connection apertures 33, 34 provided in the pipe connection member 32 and the heat medium inlet 30 and heat medium outlet 31 of the header tank member 27 on the heat medium inlet and outlet header 17 side.

Note that each of the constituent members of the flat heat exchange tubes 14, each of the constituent members of the heat medium inlet and outlet header 17, the flat heat exchange tubes 14 and the heat medium inlet and outlet header 17, and the heat medium inlet and outlet header 17 and the heat medium inlet and outlet pipes 15, 16 are joined together by brazing. However this brazing may be carried out at the same time within a furnace after temporary assembly of each of the constituent members as described above using jigs.

As illustrated in FIGS. 7 to 9, the heat exchange element 12 is a sub-assembly in which the PTC heaters 18 are incorporated into the integrated flat heat exchange tubes 14, the heat medium inlet and outlet pipes 15, 16, and the heat medium inlet and outlet header 17. The PTC heaters 18 themselves may be commonly known devices, configured with the top and bottom faces of a PTC element sandwiched between electrode plates 37, 38 on the top and bottom. The PTC heaters 18 are positioned at predetermined positions using positioning pins or the like between the flat heat exchange tubes 14 that are provided separated at predetermined intervals, with insulating sheet (not illustrated on the drawings) inserted and installed, as illustrated in FIGS. 4 and 5.

Plate-like terminals 39 having a constant width project from each of the electrode plates 37, 38 of the PTC heaters 18. The terminals 39 are each bent and project upwards, and are connected by directly screwing and fixing against a plurality of terminal mounts 46 (see FIG. 2) that are aligned on one side of the bottom face of the control substrate 13 that is described later.

As illustrated in FIGS. 4 and 5, the heat exchange element 12 as described above is incorporated between a rectangular holding plate 40 installed on the bottom face of the lowermost layer of flat heat exchange tubes 14, and an aluminum diecast substrate mount 41 fixed and installed via legs 42 with a predetermined length provided in the four corners on the holding plate 40. With the heat exchange element 12 fixed at the top and bottom faces thereof using jigs, each of the flat heat exchange tubes 14 is expanded by applying water pressure or the like inside each flat heat exchange tube 14, to bring the faces of each of the PTC heaters 18 and the faces of each of the flat heat exchange tubes 14 into mutual close contact.

The substrate mount 41 has substantially the same planar area and rectangular shape as the holding plate 40, the flat heat exchange tubes 14, and the control substrate 13, and includes the legs 42 with a predetermined length that extend downwards at the four corners. Fixing portion 42A for the pipe connection member 32 are provided on the legs 42 at one end of the substrate mount 41, and bosses 43 for fixing the control substrate 13 to the top face thereof are provided at four locations. A control circuit 44 that controls the electrical power applied to the PTC heaters 18 is mounted on the control substrate 13 that is installed and fixed by screws or the like to the bosses 43 on the substrate mount 41. The HV harness 48 and the LV harness 49 can be connected to the control substrate 13 via a connector 47 that is fixed and installed to the harness penetration part (penetration part) 11.

Also, detection signals from the inlet side and outlet side water temperature sensors 50, 51 that are installed on the water temperature sensor installation members 35A, 35B provided integrally with the pipe connection member 32 are input to the control substrate 13 via a harness 52. In addition, a plurality of power transistors 45 such as Insulated Gate Bipolar Transistor (IGBT) or the like from which the control circuit 44 is configured is installed on the bottom face side of the control substrate 13, and the plurality of terminal mounts 46 that connects the terminals 39 that extend from the electrode plates 37, 38 of the PTC heaters 18 are installed along one edge of the control substrate 13.

When the control substrate 13 is installed on the substrate mount 41 during sub-assembly, the power transistors 45 such as IGBTs that are heat generating components are installed in contact with the aluminum alloy substrate mount 41 that are installed on the top face of the flat heat exchange tubes 14, so the substrate mount 41 can cool the heat generating components as a heat sink. Also, the terminals 39 that extend from the electrode plates 37, 38 are directly connected to the terminal mounts 46 via screws or the like.

As illustrated in FIG. 2, the heat medium heating device 1 as described above is installed by penetrating the HV harness 48 and the LV harness 49 through the through hole 10, and screwing and fixing the connector 47 thereof to the lower housing side of the harness penetration part 11 to which liquid gasket has been applied. Then the heat exchange element 12 and the control substrate 13 that have been formed into a sub-assembly in advance are incorporated onto the lower housing 3, the heat medium inlet and outlet pipes 15, 16 are incorporated by inserting in the horizontal direction into the through holes 6, 7 provided in the pipe penetration face 5, and the sub-assembly is screwed and fixed by screws or the like to the plurality of bosses 3A provided on the bottom face of the lower housing 3.

A seal member 53 such as a grommet is inserted onto the outer periphery of the heat medium inlet and outlet pipes 15, 16 of heat medium that has been inserted through the through holes 6, 7 of the pipe penetration face 5, and by fixing the seal member 53 against the bosses 3B with a screw or the like the through holes 6, 7 are penetrated in a sealed manner, and the inlet and outlet pipes 15, 16 are configured to be projecting to the outside from one side face of the housing 2.

Also, after the heat exchange element 12 and the control substrate 13 that have been formed into a sub-assembly have been incorporated onto the lower housing 3 as described above, the electrical system connections are carried out on the control substrate 13, by connecting each of the HV harness 48, the LV harness 49, and the harness 52 from the water temperature sensors 50, 51 to the control substrate 13. Then, after these connections have been completed, liquid gasket is applied to the lower housing 3, and the upper housing 4 is fixed using screws or the like, thereby sealing the housing 2.

Note that in the embodiment as described above, when the control substrate 13 has been installed on the substrate mount 41 as a sub-assembly, the terminals 39 extending from the electrode plates 37, 38 are connected to the terminal mounts 46 thereof, but when connecting the harnesses to the control substrate 13, the terminals 39 may be connected to the terminal mounts 46 at the same time. Also, in the embodiment as described above, the heat exchange element 12 in which the PTC heaters 18 were inserted and installed between the flat heat exchange tubes 14 was incorporated between the holding plate 40 and the substrate mount 41, with the top and bottom faces thereof fixed by jigs. Then the flat heat exchange tubes 14 were expanded to bring the flat heat exchange tubes 14 and the PTC heaters 18 into close contact. However the following may also be carried out.

In the state in which the heat exchange element 12 that has been formed into a sub-assembly by inserting and installing the PTC heaters 18 is directly incorporated onto the bottom face of the lower housing 3, and the substrate mount 41 is fixed to the bottom face of the lower housing 3, water pressure or the like is applied within the flat heat exchange tubes 14, and each of the flat heat exchange tubes 14 is expanded to bring the flat heat exchange tubes 14 and the PTC heaters 18 into close contact. Then, the control substrate 13 may be incorporated onto the substrate mount 41, and in this way also the same effect as that for the embodiment described above can be obtained.

According to the configuration as described above, the present embodiment has the following action and effects.

Heat medium that is circulated in the heat medium heating device 1 by a pump flows into the inlet header tank part 28 from the inlet pipe 15 of the heat exchange element 12, is distributed to the four flat heat exchange tubes 14, and while flowing through the U-turn flow channels 21 is heated by the PTC heaters 18, and its temperature is raised. The heat medium that has been heated and whose temperature has been raised while flowing through the flat heat exchange tubes 14 merges in the outlet header tank part 29, and is supplied to a radiator from the outlet pipe 16, thereby supplying a heat source for space heating.

The temperature of the heat medium that has been heated by the heat medium heating device 1 is adjusted to a set temperature by measuring the inlet and outlet temperatures of the heat medium by the water temperature sensors 50, 51 installed on the water temperature sensor installation members 35, 36 provided integrally on the pipe connection member 32 that is connected to the heat medium inlet and outlet header 17, and controlling the current supplied to the PTC heaters 18 by the control substrate 13 in accordance with the measured values.

In the heat medium heating device 1, the heat exchange element 12 that is configured from the plurality of flat heat exchange tubes 14 and the PTC heaters 18 includes the plurality of flat heat exchange tubes 14 in which U-turn flow channels 21 are formed, the heat medium inlet and outlet header 17 to which the heat medium inlet and outlet pipes 15, 16 are connected at one end thereof by joints by brazing, and the plurality of sets of PTC heaters 18 that are stacked alternately between the flat heat exchange tubes 14. Also, the heat exchange element 12 is sandwiched between the substrate mount 41 and the holding plate 40 or the bottom face of the lower housing 3, and is accommodated and installed within the housing 2 with close contact between the plurality of flat heat exchange tubes 14 and the plurality of sets of PTC heaters 18.

Therefore, it is possible to achieve a brazed heat exchange element 12 in a brazed structure with no seals, so it is possible to eliminate the risk of leakage of heat medium, and increase the degree of freedom of connection position and direction of the inlet and outlet pipes 15, 16 with respect to the heat medium inlet and outlet header 17. Moreover, by sandwiching the plurality of flat heat exchange tubes 14 and the plurality of sets of PTC heaters 18 between the holding plate 40 or the bottom face of the lower housing 3 and the substrate mount 41, and accommodating and installing them in mutual close contact within the housing 2, it is possible to reduce the contact thermal resistance between them and ensure efficient heat transfer.

Therefore, it is possible to provide the heat medium heating device 1 with no risk of leakage of heat medium and high reliability, with a high degree of freedom of take out position of the inlet and outlet pipes 15, 16 and excellent mountability, and with good efficiency and high performance.

Also, the plurality of flat heat exchange tubes 14 is expanded thereby bringing the plurality of flat heat exchange tubes 14 and the plurality of sets of PTC heaters 18 into mutual close contact. Therefore even though the PTC heaters 18 were inserted maintaining a constant gap between each of the plurality of flat heat exchange tubes 14, by expanding the plurality of flat heat exchange tubes between the holding plate 40 or the bottom face of the lower housing 3 and the substrate mount 41, reliable installation is possible with mutual close contact between the plurality of flat heat exchange tubes 14 and the PTC heaters 18. Therefore, facilitating assembly of the PTC heaters 18 between the flat heat exchange tubes 14 and ensuring mutual close contact are both attained, so the assemblability of the heat medium heating device 1 is improved and high performance can be achieved.

In addition, in the present embodiment, the control substrate 13 on which power transistors 45 such as IGBTs that control the supply of electrical power to the PTC heaters 18 are mounted is installed on the substrate mount 41 that is in contact with the flat heat exchange tube 14 on the outermost side of the plurality of flat heat exchange tubes 14. Therefore, the substrate mount 41 in contact with the flat heat exchange tube 14 acts as a heat sink, and it is possible to cool the power transistors 45 such as IGBTs mounted on the control substrate 13. Therefore it is possible to ensure the cooling performance of the power transistors 45, stabilize their performance, and increase their control performance.

Also, the substrate mount 41 is made from aluminum alloy, which is a thermally conductive material. Therefore, not only is it possible to ensure both stiffness for installing the control substrate 13 and thermal conductivity as a heat sink, but also the weight of the substrate mount 41 can be reduced. Therefore, it is possible to improve both the cooling performance and the control performance of the heat medium heating device 1, and to reduce its weight.

Also, each of the flat heat exchange tubes 14, the holding plate 40, the substrate mount 41, and the control substrate 13 have a rectangular shape with substantially the same planar area. Therefore, when accommodating and installing the heat exchange element 12 and the control substrate 13 within the housing 2, it is possible to accommodate and install them with the most spatially efficient arrangement. As a result, it is possible to make the housing 2 and therefore the heat medium heating device 1 small and compact, and improve the mountability on a vehicle or the like.

Also, in the present embodiment, the terminals 39 that extend from the electrode plates 37, 38 of the PTC heaters 18 are bend upwards towards the control substrate 13, and can be directly connected to the terminal mounts 46 provided on the control substrate 13. Therefore, the electrical connection between the control substrate 13 and the PTC heaters 18 can be carried out by direct connection using the terminals 39, without a harness. In this way the configuration can be simplified, the assembly facilitated, harnesses can be eliminated, and the cost can be reduced.

In addition, in the heat medium inlet and outlet header 17, the outer face of the header plate 25 on the side that is connected to the flat heat exchange tubes 14 is made from a clad material that is clad with brazing material, and the flat heat exchange tubes 14 connected thereto are made from a clad material that is clad with brazing material only on the inner face side. Therefore, reliable joints by brazing can be made between each of the flat heat exchange tubes 14 and the heat medium inlet and outlet header 17 by the brazing material clad on the outer face of the header plate 25 of the head medium inlet and outlet header 17 connected to the flat heat exchange tubes 14. Also, brazing material is made from a clad material that is clad only on the inner face side of the flat heat exchange tubes 14, and there is no brazing material on the outer face thereof, so it is possible to prevent damage due to the brazing material to insulating sheet interposed when inserting the PTC heaters 18 between the flat heat exchange tubes 14. Therefore, the quality and reliability of the heat medium heating device 1 can be improved.

Also, in the present embodiment, the housing 2 has a box shape, with through holes 6, 7 through which the inlet and outlet pipes 15, 16 penetrate and which are then sealed provided on one end face 5, and is provided with a parting line PL that is inclined from the upper portion of the pipe penetration face 5 downwards towards the bottom portion of the opposing face 8, so that the housing 2 is configured from the lower housing 3 and the upper housing 4. Also, the housing 2 is configured so that the heat exchange element 12 and the control substrate 13 are accommodated and installed on the lower housing 3, and the top portion of the housing 2 can be sealed by the upper housing 4.

Therefore, the lower housing 3 does not have an opposing face that is opposite the pipe penetration face 5. Therefore, when incorporating the heat exchange element 12 and the control substrate 13 into the box-shaped housing 2, the inlet and outlet pipes 15, 16 can be inserted into the through holes 6, 7 of the pipe penetration face 5 by moving the heat exchange element 12 and the control substrate 13 along the bottom face of the lower housing from the horizontal direction with the upper housing removed. Then, after the peripheries of the holes have been sealed and the heat exchange element 12 and the control substrate 13 have been accommodated and installed, the top portion of the housing 2 is sealed by the upper housing 4, to assemble the heat medium heating device 1.

Therefore, it is not necessary to provide space necessary for penetrating the inlet and outlet pipes 15, 16 of the heat exchange element 12 into the through holes 6, 7 within the housing 2, so the housing 2 and therefore the heat medium heating device 1 can be made smaller and more compact by that amount, so the cost can be reduced and the mountability onto the vehicle can be improved.

Also, the harness penetration part 11 through which the HV harness 48 and the LV harness 49 penetrate is provided on one side face 9 of the box-shaped housing 2, and the HV harness 48 and the LV harness 49 with the connector 47 that are mounted on the harness penetration part 11 are connected to the control substrate 13 provided on the substrate mount 41. Therefore, after the heat exchange element 12 is accommodated and installed in the housing 2 via the substrate mount 41 and before assembling the upper housing 4, the external harnesses 48, 49 can be easily connected to the control substrate 13, by connecting the HV harness 48 and the LV harness 49 that are inserted from the harness penetration part 11 of the side face 9 of the housing 2 to the control substrate 13 on the substrate mount 41. Therefore, the external cable structure to the control substrate 13 is simplified, and it is possible to facilitate assembly of the heat medium heating device 1.

In addition, when manufacturing the heat medium heating device 1 as described above, either (1) making a sub-assembly by incorporating the heat exchange element 12 between the holding plate 40 and the substrate mount 41, expanding the plurality of flat heat exchange tubes 14 to bring the plurality of flat heat exchange tubes 14 and the plurality of sets of PTC heaters 18 into mutual close contact, and then accommodating and installing by incorporating the sub-assembly into the housing 2, or (2) incorporating heat exchange element 12 between the bottom face of the lower housing 3 and the substrate mount 41, and expanding the plurality of flat heat exchange tubes 14 to bring the plurality of flat heat exchange tubes 14 and the plurality of sets of PTC heaters 18 into mutual close contact, and accommodating and installing them within the housing 2.

Therefore, by either of methods (1) or (2), it is possible to ensure that the plurality of flat heat exchange tubes 14 and the plurality of sets of PTC heaters 18 are installed in mutual close contact, by expanding the plurality of flat heat exchange tubes 14 after inserting and installing the PTC heaters 18 while maintaining a constant gap between each of the plurality of flat heat exchange tubes 14. Therefore, facilitating stacking and assembly of the PTC heaters 18 between the flat heat exchange tubes 14 and ensuring mutual close contact are both attained, so the assemblability of the heat medium heating device 1 can be improved and its performance increased.

Also, the heat medium that has been heated by the heat medium heating device 1 can be circulated to a radiator disposed on the air flow channel of a vehicle air conditioning device. Therefore, the heat medium supplied to the radiator disposed on the air flow channel can be heated and supplied by the heat medium heating device 1 with no risk of heat medium leakage, and the heat medium heating device 1 can be provided with a high degree of freedom of positioning the take out of the inlet and outlet pipes 15, 16, with excellent mountability, good efficiency, and high performance. Therefore, it is possible to improve the air conditioning performance, in particular the heating performance, of the vehicle air conditioning device, and improve the mountability of the air conditioning device in the vehicle.

### Second Embodiment

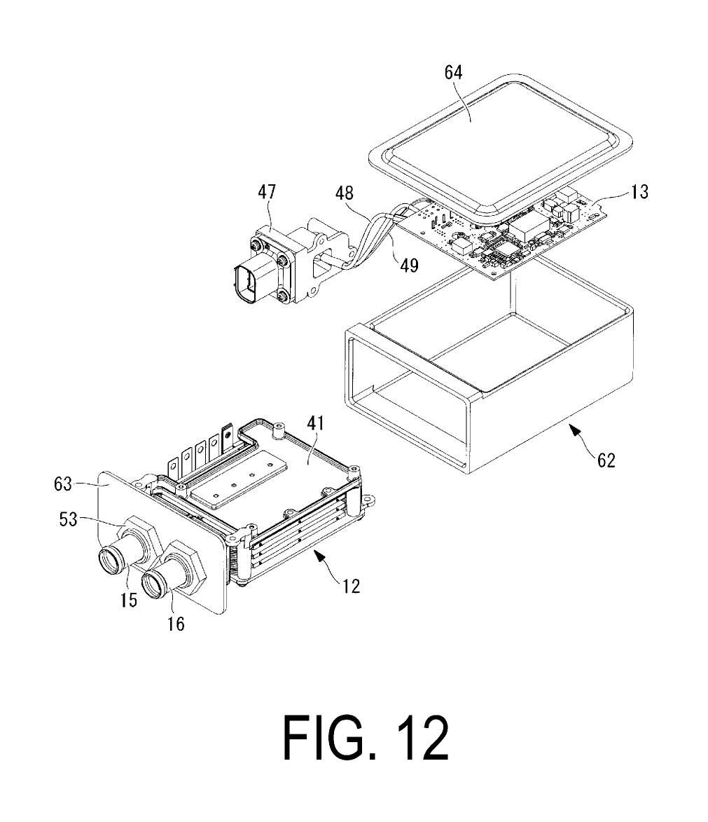

A second embodiment of the present invention will be described below, using FIG. 12.

The present embodiment differs from the first embodiment as described above in the configuration of a casing 62. Other points are the similar to the first embodiment, so their descriptions are omitted here.

In the present embodiment, the casing 62 has a box shape, and a pipe penetration face that is a one side face including the through holes 6, 7 into which the heat medium inlet and outlet pipes 15, 16 are penetrated is a side lid 63. The side lid 63 can be freely attached to and removed from the casing 62, and the top face is a top lid 64 that can be freely attached to and removed from the casing 62.

By configuring the casing 62 as described above, during assembly of the heat medium heating device 1, the side lid 63 and the top lid 64 are removed from the casing 62, and the side lid 63 is assembled onto the sub-assembly of the heat exchange element 12 and the control substrate 13. Then the through holes 6, 7 are sealed with the seal member 53 such as a grommet, and the sub-assembly of the heat exchange element 12 and the control substrate 13 is inserted into the casing 62 from the aperture formed by removing the side lid 63, so that it can be fixed and installed on the bottom face of the casing 62. Also, the aperture can be sealed by assembling the side lid 63 onto the casing 62 to which liquid gasket has been applied. In addition, after connecting the harnesses to the control substrate 13, the casing 62 can be sealed by assembling the top lid 64 onto the top face of the casing 62 after applying liquid gasket.

Therefore, according to the present embodiment, when incorporating the sub-assembly of the heat exchange element 12 and the control substrate 13 into the box shaped housing 62, the side lid 63 through which the inlet and outlet pipes 15, 16 are to penetrate and the top lid 64 are removed, the inlet and outlet pipes 15, 16 of the heat exchange element 12 are penetrated through the through holes 6, 7 of the side lid 63 and the peripheries of the holes are sealed, and the heat exchange element 12 and the control substrate 13 that are integrated with the side lid 63 are inserted into the housing 62 from the aperture formed by removing the side lid 63, so that the heat exchange element 12 and the control substrate 13 can be accommodated and installed within the housing 62. Then, the side lid 63 and the top lid 64 are assembled onto the housing 62 and the housing 62 is sealed, so as to assemble the heat medium heating device 1.

Therefore, in the same way as for the first embodiment, it is not necessary to provide space necessary for penetrating the inlet and outlet pipes 15, 16 through the through holes 6, 7 of the heat exchange element 12 within the housing 62, so the housing 62 and therefore the heat medium heating device 1 can be made smaller and more compact by that amount, so the cost can be reduced and the mountability onto the vehicle can be improved.

### Third Embodiment

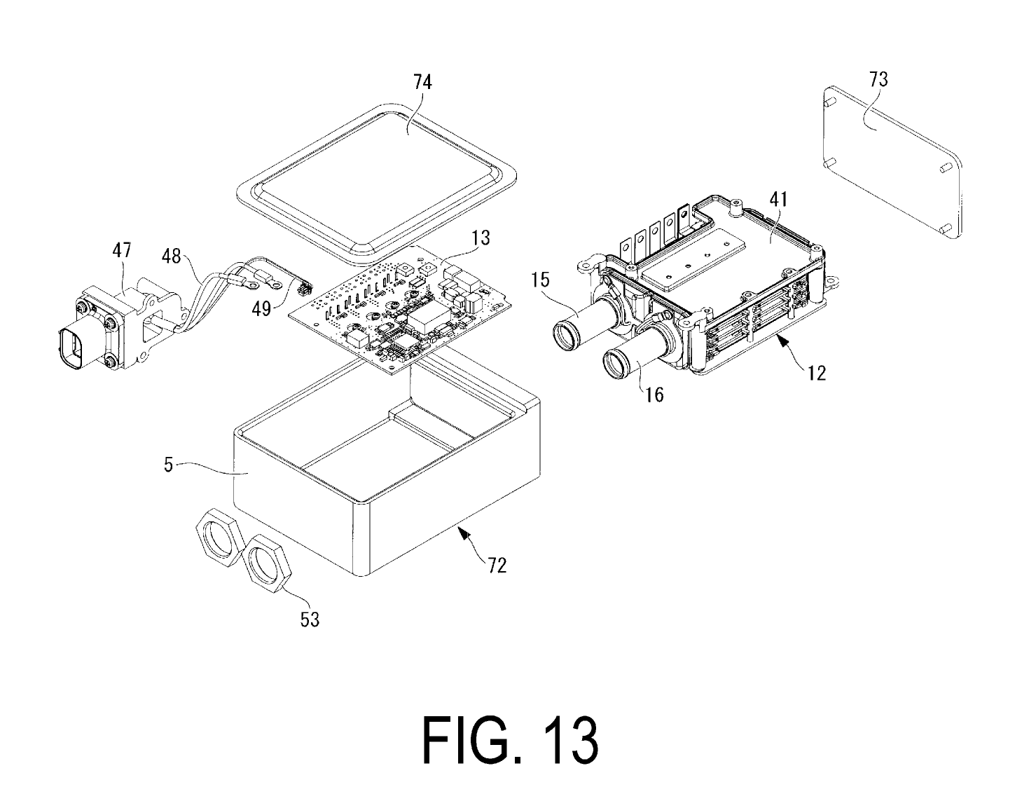

A third embodiment of the present invention will be described below, using FIG. 13.

The present embodiment differs from the first embodiment and the second embodiment as described above in the configuration of a casing 72. Other points are the similar to the first and second embodiments, so their descriptions are omitted here

In the present embodiment, the casing 72 has a box shape, one side face opposite the pipe penetration face 5 that includes the through holes 6, 7 into which the heat medium inlet and outlet pipes 15, 16 are penetrated is a side lid 73. The side lid 72 can be freely attached to and removed from the casing 72, the top face is a top lid 74 that can be freely attached to and removed from the casing 72.

By configuring the casing 72 as described above, during assembly of the heat medium heating device 1, the side lid 73 and the top lid 74 are removed from the casing 72, and the sub-assembly of the heat exchange element 12 and the control substrate 13 is inserted into the casing 72 from the aperture formed by removing the side lid 73. Then the inlet and outlet pipes 15, 16 are penetrated through the through holes 6, 7 on one side face and the peripheries thereof are sealed, and the heat exchange element 12 and the control substrate 13 can be fixed and installed on the bottom face of the housing 72. Then, the aperture can be sealed by assembling the side lid 73 onto the housing 72 to which liquid gasket has been applied. In addition, after connecting the harnesses to the control substrate 13, the casing 72 can be sealed by assembling the top lid 74 onto the top face of the casing 72 after applying liquid gasket.

Therefore, according to the present embodiment, when incorporating the sub-assembly of the heat exchange element 12 and the control substrate 13 into the box shaped housing 72, the side lid 73 that is the face opposite the side face through which the inlet and outlet pipes 15, 16 penetrate and the top lid 74 are removed, the heat exchange element 12 and the control substrate 13 are inserted from the aperture formed by removing the side lid 73, the inlet and outlet pipes 15, 16 are penetrated through the through holes 6, 7 in the side face and the peripheries of the holes are sealed, so that the heat exchange element 12 and the control substrate 13 can be accommodated and installed within the housing 72. Then, the side lid 73 and the top lid 74 are assembled onto the housing 72 and sealed, so as to assemble the heat medium heating device 1.

Therefore, it is not necessary to provide space necessary for penetrating the inlet and outlet pipes 15, 16 of the heat exchange element 12 within the housing 72, so the housing 72 and therefore the heat medium heating device 1 can be made smaller and more compact by that amount, so the cost can be reduced and the mountability onto the vehicle can be improved.

Note that the present invention is not limited to the invention according to the embodiment as described above, and changes can be made as appropriate without departing from the gist thereof. For example, in the embodiments as described above, four layers of flat heat exchange tubes 14 were provided, and the PTC heaters 18 were inserted and installed between them, but the number of flat heat exchange tubes 14 may be three or fewer, or five or more.

Also, the U-turn part of the flat heat exchange tubes 14 may be configured by integrally joining parts that are configured as separate.

In addition, in the embodiments as described above, an example in which a sub-assembly of the control substrate 13 onto the heat exchange element 12 was incorporated into the housing 72 was described. However, the control substrate 13 may be assembled on the substrate mount 41 by installation from the top face side, after the heat exchange element 12 has been incorporated into the housing 72, and any sequence may be used. Also, the box shaped housing 2 can be made from resin, but it does not necessarily have to be made from resin, but it is desirable that the material can provide strength and weight reduction.

### REFERENCE SIGNS LIST

1 Heat medium heating device
2 Housing
3 Lower housing
4 Upper housing
5 Pipe penetration face
6,7 Through hole
8 Opposing face
9 One side face
11 Harness penetration part
12 Heat exchange element
13 Control substrate
14 Flat heat exchange tube
15 Heat medium inlet pipe (inlet pipe)
16 Heat medium outlet pipe (outlet pipe)
17 Heat medium inlet and outlet header
18 PTC heater
21 U-turn flow channel
22A, 22B Formed plate
25 Header plate
28 Inlet header tank part
29 Outlet header tank part
37, 38 Electrode plate
39 Terminal
40 Holding plate
41 Substrate mount
45 Power transistor
46 Terminal mount
47 Connector
48 HV harness
49 LV harness
62,72 Housing
63, 73 Side lid
64, 74 Top lid
PL Parting line

1. A heat medium heating device heating heat medium using PTC heaters, the device comprising:
a plurality of flat heat exchange tubes, each flat heat exchange tube being formed with a U-turn flow channel, heat medium flowing in from one end thereof making a U-turn at another end thereof and returning to the one end;
a heat medium inlet and outlet header connected to heat medium inlet and outlet pipes and to the one end of each of the flat heat exchange tubes at predetermined intervals with joints by brazing; and
a plurality of sets of PTC heaters each stacked alternately between the plurality of flat heat exchange tubes;
a heat exchange element comprising the plurality of flat heat exchange tubes, the heat medium inlet and outlet header, and the plurality of sets of PTC heaters being sandwiched between a holding plate or a bottom face of a housing and a substrate mount, and being accommodated and installed within the housing with the plurality of flat heat exchange tubes and the plurality of sets of PTC heaters in a close contact state.

2. The heat medium heating device according to claim 1, wherein the plurality of flat heat exchange tubes and the plurality of sets of PTC heaters are brought into close contact by expansion of the plurality of flat heat exchange tubes.

3. The heat medium heating device according to claim 1, wherein a control substrate on which a power transistor controlling the electrical power to the PTC heaters is mounted is installed on the substrate mount that is in contact with the outermost flat heat exchange tube of the plurality of flat heat exchange tubes.

4. The heat medium heating device according to any of claim 1, wherein the substrate mount is configured from an aluminum alloy having thermal conductivity.

5. The heat medium heating device according to claim 3, wherein the flat heat exchange tubes, the substrate mount, and the control substrate each have substantially the same planar area.

6. The heat medium heating device according to claim 1, wherein a terminal extending from an electrode plate of the PTC heaters is bent towards the control substrate, and is directly connected to a terminal mount provided on the control substrate.

7. The heat medium heating device according to claim 1, wherein the flat heat exchange tube connection side of the heat medium inlet and outlet header is made from a clad material being clad with brazing material on the outer face thereof, and the flat heat exchange tubes being made from a clad material being clad with brazing material only on the inner face side thereof.

8. The heat medium heating device according to claim 1, wherein the housing has a box shape, through holes are provided on one side face of the housing, the through holes are penetrated by the inlet and outlet pipes and are then sealed, and the housing is configured from a lower housing and an upper housing provided with a parting line inclined from above the pipe penetration face towards the bottom portion of an opposing face opposite to the one side face, and the heat exchange element is accommodated and installed on the lower housing, and the top portion of the housing can be sealed by the upper housing.

9. The heat medium heating device according to claim 1, wherein the housing has a box shape, one side face provided with through holes is a side lid, the through holes are penetrated by the inlet and outlet pipes, and the top face thereof is a top lid, each of the side lid and the top lid are configured to be freely attachable and removable, and the housing can be sealed by removing the side lid and penetrating the inlet and outlet pipes of the heat exchange element through the through holes thereof and then sealing the through holes, inserting the heat exchange element into the housing from an aperture formed by removing the side lid, and after fixing and installing the heat exchange element assembling the side lid and the top lid onto the housing.

10. The heat medium heating device according to claim 1, wherein the housing has a box shape, a face thereof opposite one side face provided through holes is a side lid, the through holes are penetrated by the inlet and outlet pipes, and a top face is a top lid, each of the side lid and the top lid are configured to be freely attachable and removable, and the housing can be sealed by inserting the heat exchange element into the housing from an aperture formed by removing the side lid, penetrating the inlet and outlet pipes through the through holes of the one side face and sealing the inlet and outlet pipes, and after accommodating and installing the heat exchange element within the housing, assembling the side lid and the top lid onto the housing.

11. The heat medium heating device according to claim 1, wherein a harness penetration part is provided on one side face of the box shaped housing, a HV harness and a LV harness penetrate therethrough, and the HV harness and the LV harness with connectors mounted on the harness penetration part are connected to the control substrate provided on the substrate mount.

12. A method of manufacturing a heat medium heating device described in claim 1, wherein:
(1) making a sub-assembly by incorporating the heat exchange element between the holding plate and the substrate mount, expanding the plurality of flat heat exchange tubes to bring the plurality of flat heat exchange tubes and the plurality of sets of PTC heaters into mutual close contact, and then accommodating and installing by incorporating the sub-assembly into the housing, or
(2) incorporating the heat exchange element between the bottom face of the housing and the substrate mount, expanding the plurality of flat heat exchange tubes, bringing the plurality of heat exchange tubes and the plurality of sets of PTC heaters into mutual close contact, and thereby accommodating and installing the plurality of flat heat exchange tubes within the housing.

13. A vehicle air conditioning device configured so that heat medium heated by a heat medium heating device is circulated to a radiator disposed in an air flow channel, wherein
the heat medium heating device is a heat medium heating device described in claim 1.
